(19) United States
(12) Patent Application Publication
(10) Pub. No.: US 2014/0248052 A1
(43) Pub. Date: Sep. 4, 2014

(54) MODE-ROUTED OPTICAL NETWORKS

(71) Applicants: Guifang Li, Orlando, FL (US); Mustafa Bassiouni, Orlando, FL (US)

(72) Inventors: Guifang Li, Orlando, FL (US); Mustafa Bassiouni, Orlando, FL (US)

(73) Assignee: University of Central Florida Research Foundation, Inc., Orlando, FL (US)

(21) Appl. No.: 13/789,410

(22) Filed: Mar. 7, 2013

Related U.S. Application Data
(60) Provisional application No. 61/772,235, filed on Mar. 4, 2013.

(51) Int. Cl. H04J 14/04

(52) U.S. Cl. CPC H04J 14/04
USPC 398/44

(57) ABSTRACT

In one embodiment, an optical network includes multiple cross-connects configured to switch spatial modes in which signals are propagated across the network and multiple fiber links that extend between pairs of cross-connects, the fiber links including multimode optical fibers that support multiple spatial modes.

### CROSS-REFERENCE TO RELATED APPLICATION(S)

This application claims priority to co-pending U.S. Provisional Application Ser. No. 61/772,235, filed Mar. 4, 2013, which is hereby incorporated by reference herein in its entirety.

### BACKGROUND

Current core optical networks are enabled by wavelength-division multiplexed (WDM) transmission systems serving as point-to-point links between routers. Such routers can be electronic, in which case bits or packets of information are processed using an electronic logic gate and are forwarded to the next router. In other cases, WDM transport enables high-throughput routing and switching in the optical domain, in which case bits or packets of information carried on an entire wavelength are switched and routed completely within the optical domain using optical devices such as (reconfigurable) add-drop multiplexers [(R)OADM] and optical cross-connects (OXC).

While WDM transport increases the capacity of optical networks, there is an ever increasing demand for higher bandwidth. In view of this fact, it would be desirable to have a way to further increase the capacity of optical networks.

### BRIEF DESCRIPTION OF THE DRAWINGS

The present disclosure may be better understood with reference to the following figures. Matching reference numerals designate corresponding parts throughout the figures, which are not necessarily drawn to scale.

FIGS. 1A and 1B are schematic diagrams of an embodiment of a wavelength- and mode-routed optical network.

FIG. 2 is a schematic diagram of an embodiment of a wavelength- and mode-routed optical cross-connect.

FIG. 3 is a throughput comparison in the U.S. long haul network (W=20, arrival rate=35/s, g=0.5).

FIG. 4 is a throughput comparison in a 5×5 mesh torus network (W=20, arrival rate=35/s, g=0.5).

FIG. 5 is a throughput comparison in a 5×5 mesh torus network (W=20, g=0.5, modes=3).

FIG. 6 is a graph of per-hop dropping probabilities in the U.S. long haul network for SPF (W=20, g=0.5, modes=3).

FIG. 7 is a graph of per-hop dropping probabilities in the U.S. long haul network for FFOR (W=20, g=0.5, modes=3).

FIG. 8 is a graph of per-hop dropping probabilities in the U.S. long haul network for FTFOR (W=20, g=0.5, modes=3).

### DETAILED DESCRIPTION

As described above, it would be desirable to have a way to further increase the capacity of optical networks. Described herein are spatial mode-routed optical networks that are adapted to multiplex communication signals using different spatial modes to provide mode-division multiplexing (MDM). In some embodiments, the networks are further adapted to multiplex communication signals using different wavelengths to provide wavelength-division multiplexing (WDM). When both MDM and WDM are provided by the optical network, the network can be designated a wavelength- and mode-routed optical network.

In the following disclosure, various specific embodiments are described. It is to be understood that those embodiments are example implementations of the disclosed inventions and that alternative embodiments are possible. All such embodiments are intended to fall within the scope of this disclosure.

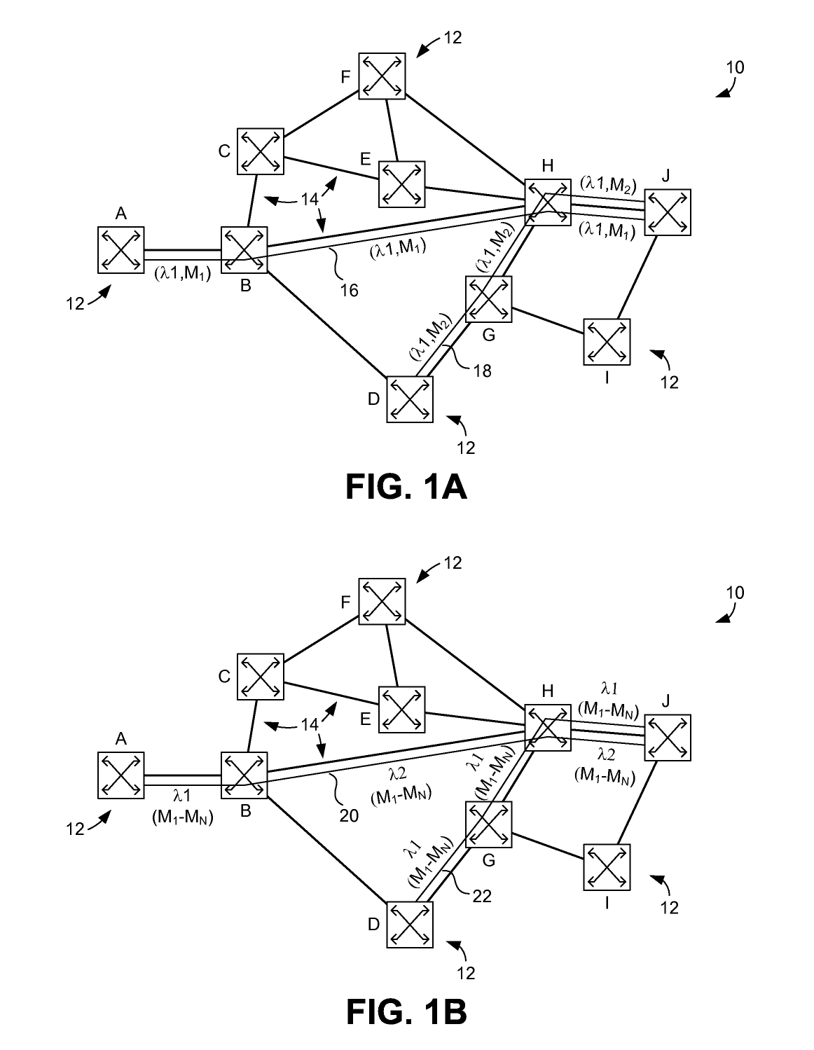

Described in this disclosure are spatial mode-routed optical networks (MRNs) that reduce blocking probability and increase throughput of optical signals. FIGS. 1A and 1B illustrate an example MRN 10 that has a mesh topology. Although a mesh topology is shown in FIGS. 1A and 1B, it is noted that other topologies can be used, such as ring, bus, or star topologies, or combinations thereof. The MRN 10 includes multiple optical cross-connects 12, which are labeled A-J. The cross-connects 12 are configured to switch the spatial modes on which signals are propagated in the network 10. The cross-connects 12 can therefore be referred to as optical mode cross-connects (OMXCs).

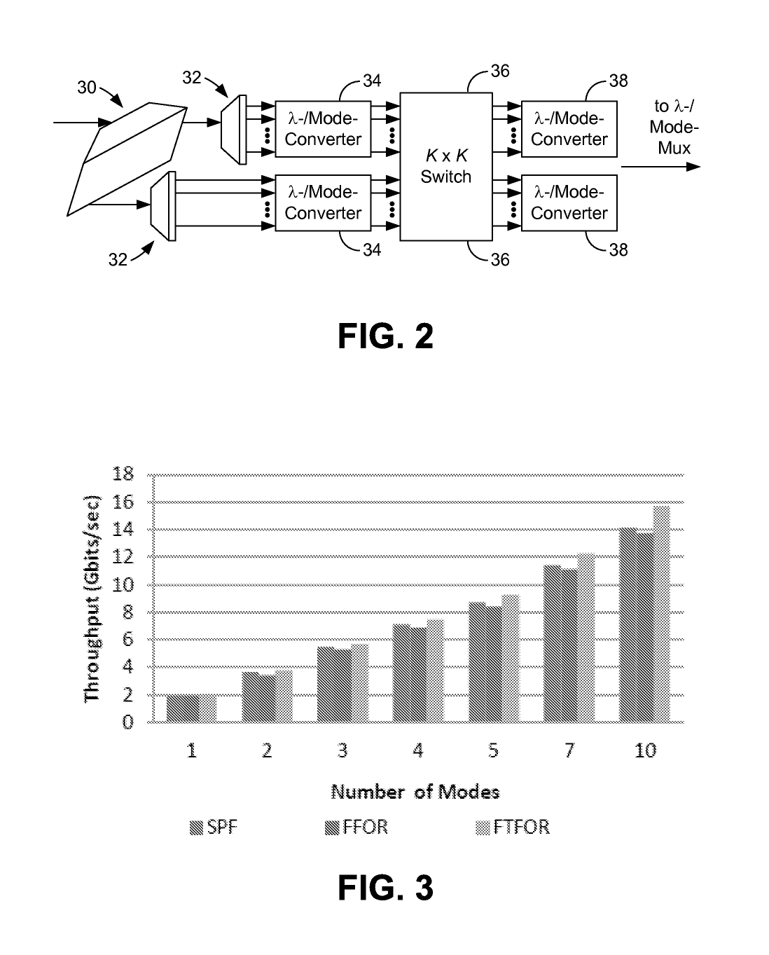

FIG. 2 illustrates an example configuration for one of the cross-connects 12. As shown in FIG. 2, the cross-connect 12 includes a mode-division demultiplexer 30 that divides an input multiplexed signal into multiple modes and wavelength-division demultiplexers 32 that divide the (mode) demultiplexed signals into multiple demultiplexed signals having different wavelengths. The cross-connect 12 further comprises first wavelength- and mode-converters 34 that convert the demultiplexed signals into the electrical domain, an electrical switch module 36 that switches the signals, and second wavelength- and mode-converters 38 that convert the demuliplexed signals back into the optical domain.

With reference back to FIGS. 1A and 1B, fiber links 14 extend between multiple pairs of cross-connects 12 within the network 10. Each fiber link 14 comprises at least one multimode optical fiber that not only supports multiple wavelengths but also multiple spatial modes for each wavelength. In some embodiments, the multimode optical fiber supports a number of spatial modes that is less than that supported by conventional multimode fiber (which typically supports hundreds of modes) to decrease mode coupling. Such fibers can be designated as “few-mode optical fibers” or simply “few-mode fibers.” In some embodiments, the few-mode fibers support approximately 2 to 50 spatial modes. In other embodiments, the few-mode fibers support approximately 2 to 10 spatial modes. In further embodiments, the few-mode fibers support approximately 2 to 5 spatial modes.

Because the fiber links 14 support multiple wavelengths and multiple spatial modes for each wavelength, signals can be transmitted across the network using multiple wavelengths, multiple modes, or both. FIG. 1A illustrates a first example in which two transmissions are carried out using the same wavelength but two different spatial modes. As shown in that figure, a first signal 16 is to be transmitted from cross-connect A to cross-connect J and a second signal 18 is to be transmitted from cross-connect D to cross-connect J. The first signal 16 is transmitted from cross-connect A to cross-connect B to cross-connect H and to cross-connect J using a first wavelength λ1 and a first spatial mode M₁ (e.g., the fundamental mode). The second signal 18 is transmitted from cross-connect D to cross-connect G to cross-connect H to cross-connect J using the first wavelength λ1 and a second spatial mode M₂ (e.g., the first high order mode). Although both signals 16, 18 are simultaneously transmitted across the fiber link 14 that extends between cross-connect H and cross-connect J using the same wavelength, the signals do not interfere with each other because they are transmitted using separate spatial modes of the link.

FIG. 1B illustrates a second transmission example. In this example, transmission is achieved using both multiple wavelengths (λ1 and λ2) and multiple spatial modes (M₁-M_{N}). As shown in that figure, a first signal 20 is transmitted from cross-connect A to cross-connect J using both λ1 and λ2 and one of the modes M₁-M_{N} and a second signal 22 is transmitted from cross-connect D to cross-connect J using λ1 and one of the modes M₁-M_{N}. Because different wavelengths are used to transmit the two signals from cross-connect H to cross-connect J, the same mode (or different modes) can be used for the two transmissions.

From the above examples, it can be appreciated that the cross-connects 12 in the MRN 10 can switch one or both of the wavelength and spatial mode of an incoming signal. Therefore, a signal using a first mode at a first wavelength can be converted to a signal using the first mode at a different wavelength, or to a signal using a second mode at the first wavelength, or a second mode at a second wavelength.

The routing scheme shown in FIGS. 1A and 1B may be particularly advantageous in certain applications, such as when traffic is much greater than the data rate of the fastest transceivers. In such a scheme, it is possible to switch and/or route a large amount of data. High-throughput routing and switching in the optical domain can be achieved by operating on wavelengths that carry more than one spatial mode using multimode optical cross-connects (MMOXCs) having input/output wavelengths that support more than one spatial mode. MMOXCs are different from OMXCs because they simultaneously operate on a group of modes on a wavelength, rather than operating on modes one by one as in the case of an OMXC.

The cross-connects 12 of the MRN 10 can be single-mode input or multimode input. Add-drop multiplexers, whether single-mode input or multimode input, can also be used at the various nodes of the MRN 10. The MRN 10 can be circuit switched, flow switched, or packet switched. Furthermore, the MRN 10 can be static or dynamic.

The above-described wavelength- and mode-division multiplexing shows promise for meeting the ever-increasing bandwidth demands of network users. Described below are two routing schemes for alleviating the fairness problem in optical burst switching (OBS) networks that use wavelength- and mode-division multiplexing. The schemes use formulas that adjust the size of the search space for a free mode or a free wavelength based on the distance of the current hop of the burst from the source node. Additionally, the second scheme uses a formula to adjust the size of the search based on the size of the burst, thereby attaining higher throughput without sacrificing hop count fairness. Performance test results were performed to evaluate the two schemes and analyze their effectiveness in improving fairness without negatively impacting network throughput.

OBS networks often experience a hop count fairness problem. The optical bursts traveling through longer light paths with larger hop counts tend to have higher dropping probabilities than bursts with light paths having a smaller number of hops. Previously, the hop count fairness problem in OBS networks has been investigated in the context of single-mode fibers. In one study, an OBS reservation scheme was proposed using a parallel backward reservation paradigm in OBS networks operated under the wavelength-continuity constraint. The fairness was achieved by classifying bursts into several groups according to their total hop counts and then limiting the number of wavelengths dedicated to the group with shorter-hop bursts. Two schemes were proposed in another study to alleviate the fairness problem in OBS networks. In the first scheme, the size of the search space for a free wavelength is adjusted based on the number of hops traveled by the burst. The second scheme uses the concept of random early discard (RED). This scheme applies proactive discarding of bursts at the network access station (NAS) using discarding probabilities computed based on the hop count of the light path of the burst. In a third study, a fairness-aware hop implemented hop-adaptive routing scheme uses metrics based on forward channel reservation or link connectivity. All previous schemes have addressed the fairness problem in the context of single-mode fibers. Described in the following paragraphs are schemes for solving the fairness problem in OBS networks that use mode-division multiplexing.

A first fairness scheme is referred to herein as fairness formula-based optical routing (FFOR). This scheme is proposed in order to address the hop count fairness problem that exists in the standard shortest path first (SPF) algorithm. In the FFOR scheme, at any node, the control packet will try to use the same wavelength and same mode that were used in the previous hop. If this is not possible, it will attempt mode conversion first. It is assumed that mode converters as well as wavelength converters are present in the switching/routing component throughout the network. Using Equation 1 below, the search is conducted for a free mode on the same wavelength used in the previous hop using a subset of the total set of available modes.

Mode search size=┌i*M/D┐ (1)

where M is the maximum number of modes, D is diameter of the network (the largest light path in the network), and i is the current hop. The factor i/D determines the size of the subset of modes to be searched among the total modes M and it increases with the number of hops travelled by the burst. When i=D, all M modes are searched. The ceiling function is used to yield an integer number of modes subset that should be at least equal to 1. For example, if the network diameter is D=10, the number of modes searched is 0.1*M at the first hop, 0.2*M at the second hop, and so on.

If no mode is free, FFOR then attempts wavelength conversion. Equation 2 determines the subset of wavelengths that can be searched, keeping the same mode as the previous hop:

nᵢ=(1−g)*W_{M}+g*i*W_{M}/D, 0≦g≦1 (2)

where nᵢ is number of wavelengths searched at the ith hop, W_{M} is the maximum number of wavelengths per mode, and g is a constant between 0 and 1 inclusive. Because the value of M is practically much smaller than the value of W_{M}, a different equation for the wavelength search has been used that always includes a subset with a base size. The parameter g divides the search spectrum in each cross-connect into two parts: a base part and an adjustable part. The base part has a fixed size of (1−g)*W_{M} wavelengths regardless of the hop count of the light path. The adjustable part gives higher priority (larger wavelength subset) to the burst having travelled the larger distance and can reach a maximum size of g*W wavelengths. For example, if the network diameter D is 10, the size of the adjustable part is 0.1*g*W at the first hop, 0.2*g*W at the second hop, and so forth.

The parameter g controls the degree of effectiveness of resolving fairness. Generally speaking, the larger the value assigned to g, the better fairness but this is at the expense of dropping some bursts that have shorter hops to destination. A good value of g has been found to be around 0.5.

If none of these wavelengths is free, FFOR will start searching in the entire subset with both mode and wavelength conversion using Equation 3.

Wavelength-mode search size=(1−g)*W_{M}*M+g*i*M*W_{M}/D, 0≦g≦1 (3)

It can be seen in each of the above equations that the subset for either modes or wavelengths or both depends on the current hop distance of the control packet from the source cross-connect. When the burst is closer to the destination, a larger subset of wavelengths or modes is searched to find and reserve a free wavelength and mode. If at a particular node, the control packet is unable to find a free wavelength from the designated subset on all available modes, the packet is considered blocked and gets dropped.

A second fairness scheme is referred to herein as fairness throughput formula-based optical routing (FTFOR). FFOR is sufficient for improving fairness in OBS networks but does not attempt to improve throughput further. In an OBS network, the arriving bursts typically are of different sizes and a bandwidth reservation technique can simply look into the burst size in order to enhance the overall throughput of the system. FTFOR incorporates the burst size to positively enhance throughput. A new term, the size factor η, is introduced, which is the ratio of current burst size S to the maximum allowed burst length Sₘₐₓ. The search equations for FTFOR are given below.

Mode search size ┌i*M*η/D┐ (4)

where,

η=S/Sₘₐₓ

S: burst length

Sₘₐₓ: max allowed burst length

Equation 4 yields a larger subset of modes for larger bursts and longer light paths thereby improving fairness and throughput. The role of the factor i/D and the ceiling function are the same as already mentioned in the FFOR scheme.

If the mode search fails, wavelength conversion is attempted. The wavelength search subset is given by:

n₁=(1−g)*W_{M}*η+g*i*W_{M}*η/D, 0≦g≦1 (5)

In Equation 5, the size factor η has been introduced. With the presence of the size factor, a larger subset of wavelengths is searched for larger bursts, thereby giving them a higher probability to reach the destination successfully. If the above search fails, both wavelength and mode are changed using Equation 6.

(1−g)*W_{M}*M*η+g*i*M*W_{M}*η/D, 0≦g≦1 (6)

The size factor η adjusts the wavelength search subset based on the size of the current burst and allows a larger number of wavelengths to be searched for larger bursts. Consequently, for two bursts of different sizes but with the same hop count, FTFOR will allow a larger wavelength search space to the burst that is of larger size. Because the hop count of the burst is independent of its size, FTFOR tends to have the same level of fairness as FFOR but achieves higher throughput.

The above-described fairness schemes have been extensively tested using a simulation test bed written in C++. The simulation assumes that assembled bursts arrive at the network with Poisson distribution. The arrival rate λ is controllable and both schemes FFOR and FTFOR are tested and compared with SPF using various network loads and burst sizes. A source-destination pair is randomly chosen for each arriving burst. To establish the static light path, the simulation calculates the shortest path between these nodes using Dijkstra's algorithm. The network nodes are assumed to be equipped with mode as well as wavelength converters. The control packet that originates from the source node acquires an initial free wavelength and mode, then travels to the destination using the just-in-time signaling protocol. When blocked at the next hop, the control packet searches for the same wavelength on all available modes. If the same wavelength is not available when it tries wavelength conversion, it tries both mode and wavelength conversion. The process continues until the control packet either reaches the destination node or gets blocked due to the unavailability of free wavelength on all modes at any hop along the path. The source node waits for a predetermined time depending on the hop distance to the destination before transmitting the optical burst message.

The simulation clock is divided into time units, where each simulation time unit corresponds to 1 millisecond. The optical node and network parameters are similar to those typically used in the literature. Each node has a control packet processing time of 10 milliseconds and its cut through time is set to 1 millisecond. In order to evaluate the performance of the disclosed schemes, variable burst sizes between Sₘᵢₙ=250 Mbits to Sₘₐₓ=1000 Mbits were used. Each node can have a certain maximum number W of allowed wavelengths and all the schemes are tested using the same value of W. Each of the performance graphs described below was generated by averaging 7-10 tests where each test was run for a sufficiently large number of time units to produce stable results.

The topologies used in the simulation tests are the U.S. long haul network with 28 nodes and a 5×5 mesh torus network. The longest light path in the U.S. long haul network has the diameter of 8 hops while that of the 5×5 mesh torus network is 4 hops. The traffic used in the simulation is uniformly distributed, i.e., any node can be a source or a destination. The mesh torus network has more links than the long haul network and it often has multiple shortest-path routes connecting the same source-destination pair. The mesh torus network therefore requires higher total load than the long haul network to induce a certain level of congestion on the individual links.

Solutions to remedy fairness usually have the side effect of decreasing the overall throughput of the network. Before examining the fairness performance, it is shown that the proposed schemes do not negatively impact the throughput of the network and that FTFOR actually improves the throughput. FIG. 3 shows the throughput of the U.S. long haul network for the schemes SPF, FFOR, and FTFOR under various available numbers of modes with burst arrival rate of 35 bursts/s. It can be observed that the throughput of FFOR is roughly the same as that of SPF or very slightly smaller while the throughput of FTFOR is generally higher.

It is also interesting to note that the gain in throughput for increasing the number of modes is multiplicative, e.g., the throughput with three modes is triple the throughput with a single mode.

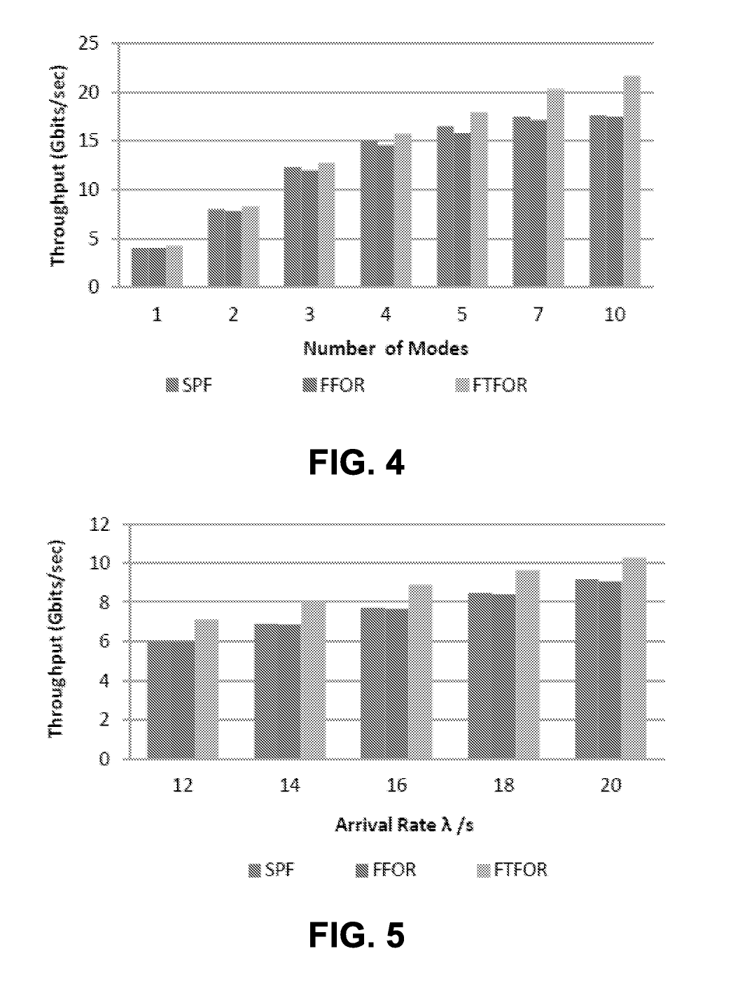

FIG. 4 shows the throughput for the 5×5 mesh torus network with a burst arrival rate of 35 bursts/s. Again the schemes SPF, FFOR, and FTFOR show the multiplicative trend of increasing throughput when the number of modes is increased. FTFOR performs best while the throughput of FFOR is very slightly smaller. This is a very small penalty for achieving better fairness.

FIG. 5 shows the throughput of the three schemes with three modes and different arrival rates for the 5×5 mesh topology. Similar results have been obtained for the U.S. long haul topology.

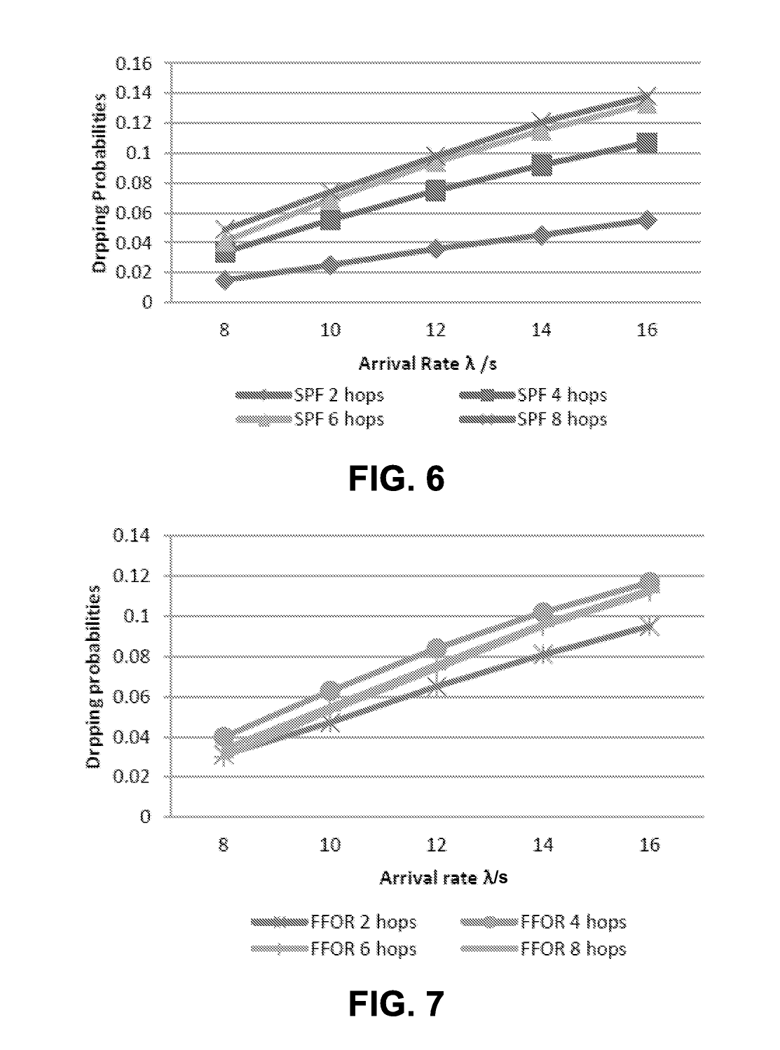

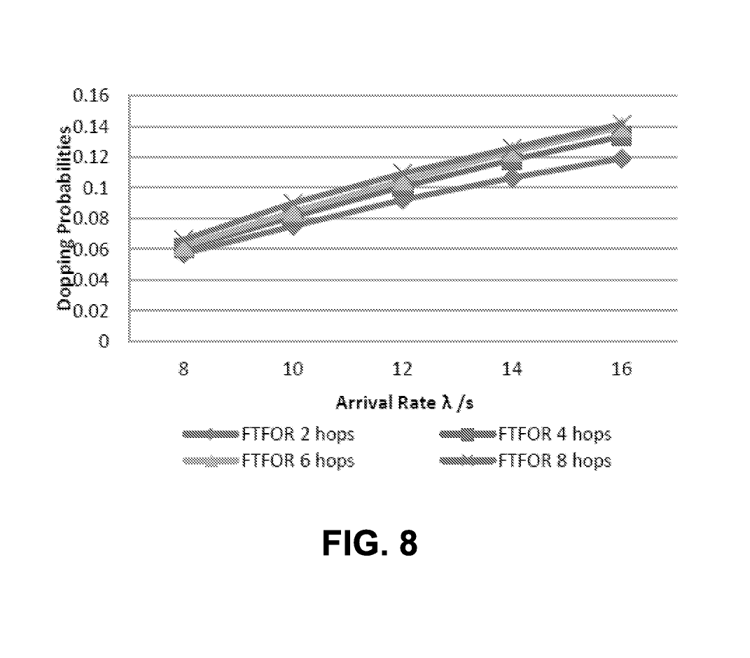

FIG. 6 shows the per hop dropping probabilities in the U.S. long haul for SPF while FIG. 7 and FIG. 8 show the corresponding per hop dropping probabilities for FFOR and FTFOR, respectively. It can be observed from these figures that the dropping probabilities in SPF for smaller hop counts (e.g., 2 hops or 4 hops) are much less than the dropping probabilities for larger hop counts (e.g., 6 hops or 8 hops). This is the expected behavior of all optical routing schemes that do not have fairness-improving mechanisms. Under SPF and similar routing protocols, the delivery of bursts between two nodes far away from each other is much less reliable and has lesser throughput than the delivery of bursts between two nodes that are near each other. FIG. 7 and FIG. 8 clearly show that the bias against bursts with longer light paths is substantially decreased when FFOR or FTFOR are used. Compared to FIG. 6, small and large hop counts in FIG. 7 and FIG. 8 exhibit small differences in the blocking probabilities at all arrival rates. It is no longer the case that a connection between two distant nodes will have significantly less throughput than a connection between two nearby nodes.

The coefficient of variation (standard deviation over the mean) of the individual average blocking probabilities for bursts with different hop counts were calculated to evaluate the fairness of the FFOR and FTFOR schemes. These coefficients are contained in Table 1. This metric can be considered to be the unfairness coefficient: the smaller the value of the unfairness coefficient the better the fairness of the scheme. Table 1 shows the improved fairness of FFOR and FTFOR over SPF for all the arrival rates. The coefficient of unfairness decreases with increasing arrival rate λ. It can be clearly observed that both new schemes FFOR and FTFOR have much better fairness in multimode fiber networks than the standard SPF routing protocol.

TABLE 1
Unfairness Coefficient for U.S. Long Haul Network

| Arrival Rate λ | SPF | FFOR | FTFOR |
|---|---|---|---|
| 8 | 0.60 | 0.39 | 0.39 |
| 10 | 0.56 | 0.38 | 0.37 |
| 12 | 0.54 | 0.36 | 0.36 |
| 14 | 0.53 | 0.35 | 0.35 |
| 16 | 0.51 | 0.34 | 0.34 |

1. An optical network comprising:
multiple cross-connects configured to switch spatial modes in which signals are propagated across the network; and
multiple fiber links that extend between pairs of cross-connects, the fiber links including multimode optical fibers that support multiple spatial modes.

2. The optical network of claim 1, wherein the cross-connects are further configured to switch wavelengths at which signals are propagated across the network and the multimode optical fibers support multiple wavelengths such that the optical network is a wavelength- and mode-routed optical network.

3. The optical network of claim 2, wherein the cross-connects comprise a mode-division demultiplexer and a wavelength-division demultiplexer.

4. The optical network of claim 3, wherein the cross-connects further comprise wavelength- and mode-converters that convert demultiplexed optical signals into the electrical domain and an electrical switch that switches the signals.

5. The optical network of claim 2, wherein the multimode fibers support approximately 2 to 50 spatial modes.

6. The optical network of claim 2, wherein the multimode fibers support approximately 2 to 10 spatial modes.

7. The optical network of claim 2, wherein the multimode fibers support approximately 2 to 5 spatial modes.

8. A method for routing signals in an optical network, the method comprising:
receiving a signal transmitted using a first spatial mode and a first wavelength; and
transmitting the signal using (a) a second spatial mode and the first wavelength, (b) the first spatial mode and a second wavelength, or (c) a second spatial mode and a second wavelength.

9. The method of claim 8, wherein receiving a signal comprises receiving the signal from a fiber link that comprises a multimode optical fiber that supports multiple spatial modes.

10. The method of claim 9, wherein the multimode optical fiber supports approximately 2 to 50 spatial modes.

11. The method of claim 8, wherein transmitting the signal comprises transmitting the signal with a cross-connect that is configured to change the wavelength, spatial mode, or both of the received signal.

12. The method of claim 11, wherein the cross-connect comprises a mode demultiplexer and a wavelength demultiplexer.

13. A method for routing signals in a wavelength- and mode-routed optical network, the method comprising:
determining whether a received signal can be transmitted using the same wavelength and mode that was last used to transmit the signal;
if the signal cannot be transmitted using the same wavelength and mode, determining whether the signal can be transmitted using the same wavelength but a different mode;
if the signal cannot be transmitted using the same wavelength and a different mode, determining whether the signal can be transmitted using the same mode but a different wavelength; and
if the signal cannot be transmitted using the same wavelength and a different mode or using the same mode and a different wavelength, determining whether the signal can be transmitted using both a different mode and a different wavelength.

14. The method of claim 13, wherein determining whether the signal can be transmitted using a different mode comprises searching a subset of modes supported by the network.

15. The method of claim 14, wherein determining whether the signal can be transmitted using a different wavelength comprises searching a subset of wavelengths supported by the network.

16. The method of claim 15, wherein the size of the subsets depends upon the a current hop distance from a source cross-connect of the network.

17. The method of claim 16, wherein the smaller the current hop distance, the larger the subsets that are searched.

18. The method of claim 15, wherein the size of the subsets depends upon an adjustable size factor that is a ratio of a current burst size to a maximum allowed burst length.

19. The method of claim 18, wherein the larger the size factor, the larger the subsets that are searched.
